(19) United States
(12) Patent Application Publication
(10) Pub. No.: US 2003/0233384 A1
(43) Pub. Date: Dec. 18, 2003

(54) Arithmetic apparatus for performing high speed multiplication and addition operations

(75) Inventor: Osamu Nishii, Inagi (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/443,809

(22) Filed: May 23, 2003

(30) Foreign Application Priority Data
Jun. 17, 2002 (JP) P2002-175169

(51) Int. Cl. G06F 7/52

(52) U.S. Cl. 708/620

(57) ABSTRACT

An arithmetic unit that performs high speed multiplication and addition operations is provided. The arithmetic unit is applicable to an instruction set not having a multiplication-addition instruction. The arithmetic circuit included in a data processing device is configured to have: a multiplication device (EMUL1) to which data A and B are inputted and which outputs partial signals, sum signal (113) and carry signal (114), for computing A*B; a first addition device (EADD1) which adds the sum signal and the carry signal to compute the final result of A*B; and a second addition device (EADD2) which receives data E, the sum signal, and the carry signal and is capable of computing the result of adding E to A*B. The arithmetic circuit selects among three types of operations, multiplication (A*B), addition (D+E), and multiplication-addition (A*B+E) by selection circuits 104 and 105.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a digital information processing device and a signal processing device. More particularly, it relates to a multiplication device and an addition device included in the signal processing device.

2. Discussion of Background

Documents referred to in this specification are as described below. [Document 1]: Chandrakasann et al, “Design of High-Performance Microprocessor Circuits”, IEEE Press, 2000, pages 181 to 200 [Document 2]: JP-A No. 92636/2001 (U.K. Patent 2355823 (disclosed on May 2, 2001).

Document 1 discloses the respective element circuits of a multiplication device and an addition device used in digital information processing and signal processing. With respect to the multiplication device, for the purpose of high speed processing, Document 1 introduces a technique by which individual bit products in an n-bit by n-bit multiplication are added by a carry save addition device and finally by a 2n-bit carry propagate addition device (CPA), and states that the number of partial products to be added can be reduced by a Booth algorithm. The multiplication device is activated by a multiplication instruction.

On the other hand, with respect to the addition device, it is introduced that a carry lookahead addition device for speedup is used so that addition of n bits+n bits can be processed in operation time of order log(n). Since the carry propagate addition device in the multiplication device is only another term of addition device, the speedup method by the carry propagate addition device (CPA) is identical with the speedup method by this addition device. This addition device is activated by an addition instruction or also in the form of addition processing in addressing of load/store instructions.

Document 2 discloses the hardware of a so-called multiplication-addition device consisting of a combination of multiplication device and addition device. FIG. 3A of Document 2 shows a structure in which mantissas B and C are inputted to a partial multiplication device in a fused multiplication-cumulation FPU, and a total of three data, two data resulting from the multiplication and mantissa A, are added by a carry save addition device. This arithmetic unit outputs the result of a product-sum operation B*C+A.

Multiplication and addition are frequently processed in digital information processing and signal processing. As examples, the array operation of multiplying an N-by-N array by a vector of N in numerical processing in information processing consists of N2 number of multiplications and N(N−1) number of additions (when N is large, any major terms are the square of N). On the other hand, since FIR (finite impulse response) filter processing in the digital signal processing field yields the operation of multiplying N number of input signal trains by N number of weighted coefficients and summing the multiplications, N number of multiplications and (N−1) number of additions are performed. The two examples are called a product-sum type because product terms are cumulated; a pair of one multiplication and one addition, that is, a product-sum operation, is repeated as a unit operation to find a solution.

Problems are associated with conventional multiplication-addition operations in a one-chip microprocessor (MPU), conventional instruction sets, and conventional methods of constructing required circuits.

Many microprocessors have multiplication instructions and addition instructions, as well as dedicated multipliers and dedicated adders corresponding to the instructions. However, not all microprocessors have multiplication-addition instructions and some microprocessors do not traditionally have multiplication-addition instructions. Microprocessors not having the multiplication-addition instructions, when a product-sum operation occurs, can perform the operation by combining existing multiplication and addition instructions. In this case, however, since the microprocessors serially pass through a multiplication device and an addition device and pass through twice N-bit carry propagate adders included in them, operation speed does not become minimum. In comparison with the case of using multiplication-addition device dedicated hardware, processing time corresponding to almost one stage of the carry propagate addition device is redundantly required.

Therefore, a conceivable method is to expand a microprocessor's instruction set to add a new multiplication-addition instruction and a corresponding multiplication-addition device corresponding. In this case, however, the following problems occur: (1) a multiplication-addition device having a circuit almost similar to those of an existing multiplication device and addition device is redundantly added, so that a chip area is wastefully used for the added circuit; and (2) previously written programs performing multiplication-addition operations using multiplication and addition instructions do not benefit from a higher operation speed brought about by a multiplication-addition device because they were not written in multiplication-addition instructions.

Furthermore, where a dedicated multiplication-addition instruction is used, if a program does not use intermediate results of multiplication, the program benefits from reduction in operation time; if the program uses intermediate results of multiplication, operation time may not be reduced. Typically, such a problem occurs in the following computation example. That is, assuming that a register operation instruction set operates on registers R0 to R15, the following processing is performed:

compute (data #1)*(data #2) into (data #3);

compute (data #3)+(data #4) into (data #5); and

compute (data #3)+(data #6) into (data #7). In this case, if a multiplication-addition instruction is properly used, although a multiplication-addition operation {(data #1)*(data #2)}+(data #4) is performed, (data #5) will be obtained but the equivalent of (data #3) at the time of multiplication will not be left. To avoid this problem requires that (data #3) be multiplied again, or a differential value {(data #6)−(data #4)} be added to (data #5) to obtain (data #7). The former requires double the number of multiplications. The latter requires one more subtraction processing.

As other circumventing measures, without using multiplication-addition instructions, using simple multiplication and addition instructions, multiplication results are obtained and two additions are made to the results. In this case, although no redundant operations occur, since reduction in operation time brought about by multiplication-addition instructions does not occur, the significance of having added the multiplication-addition instructions is lost.

### SUMMARY OF THE INVENTION

Broadly speaking, the present invention provides an arithmetic unit that performs high speed multiplication and addition operations. The arithmetic unit is applicable to an instruction set not having a multiplication-addition instruction. It should be appreciated that the present invention can be implemented in numerous ways, including as a process, an apparatus, a system, a device or a method. Several inventive embodiments of the present invention are described below.

Generally, a block element or a group of block elements in a figure may be referred to as a device. The term “device” as used in the present invention means hardware, software, or combination thereof.

In one embodiment, data processing device including an arithmetic circuit is provided. The arithmetic circuit comprises a first input node configured to receive first data; a second input node configured to receive second data; a multiplication device configured to receive the first and second data and to output a sum signal and a carry signal, which are partial signals for computing a product between the first and second data; a first addition device configured to add the sum signal and the carry signal to compute the result of the product between the first and second data; a first output node configured to output a computation result of the first addition device; a third input node configured to receive third data; a second addition device configured to receive the third data, the sum signal, and the carry signal, and further configured to add the third data to a product between the first and the second data; and a second output node configured to output a computation result of the second addition device.

In another embodiment, a data processing device is provided that comprises a multiplication instruction for multiplying two data in an instruction set, wherein a latency required to execute the multiplication instruction depends on an instruction executed after the multiplication instruction.

In still another embodiment, a data processing device having an arithmetic circuit is provided. The arithmetic circuit comprises a first input node configured to receive first data; a second input node configured to receive second data; a multiplication device configured to receive the first and the second data and to output a sum signal and a carry signal, which are partial signals for computing a product between the first and the second data; a first addition device configured to add the sum signal and the carry signal to compute the result of the product between the first and the second data; a first output node configured to output a computation result of the first addition device; a third input node configured to receive third data; a fourth input node configured to receive fourth data; a second addition device; and a second output node configured to output a computation result of the second addition device, wherein the second addition device is configured to switch between the operation of adding the third data, the sum signal, and the carry signal, and the operation of adding the third data and the fourth data.

The invention encompasses other embodiments of a method, an apparatus, and a system which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram containing an arithmetic unit of the present invention and data processing circuits around it, in accordance with one embodiment of the present invention;

FIG. 2 is a block diagram showing the inside of a multiplication array 101, in accordance with one embodiment of the present invention;

FIG. 3 is a block diagram showing the whole of a processor LSI employing the arithmetic unit, in accordance with one embodiment of the present invention;

FIG. 4 is a diagram showing pipeline stages of multiplication and addition instructions of a processor using the present invention, in accordance with one embodiment of the present invention;

FIG. 5 shows an operation example, in accordance with one embodiment of the present invention;

FIG. 6 shows an operation example, in accordance with one embodiment of the present invention;

FIG. 7 shows an operation example, in accordance with one embodiment of the present invention;

FIG. 8 shows the logic of detecting instruction strings having a multiplication-to-addition dependence relationship, in accordance with one embodiment of the present invention;

FIG. 9 shows part of latencies of the external specification (manual), in accordance with one embodiment of the present invention; and

FIG. 10 shows an operation example, in accordance with one embodiment of the present invention.

### DESCRIPTION OF THE PREFERRED EMBODIMENTS

An arithmetic unit that performs high speed multiplication and addition operations is provided. The arithmetic unit is applicable to an instruction set not having a multiplication-addition instruction. Numerous specific details are set forth in order to provide a thorough understanding of the present invention. It will be understood, however, to one skilled in the art, that the present invention may be practiced without some or all of these specific details.

Although there is no particular limitation, circuit elements constituting blocks of the embodiment are preferably formed on one semiconductor substrate such as a single-crystal silicon by semiconductor integrated circuit technology such as known CMOS transistors (complementary MOS transistors) and bipolar transistors.

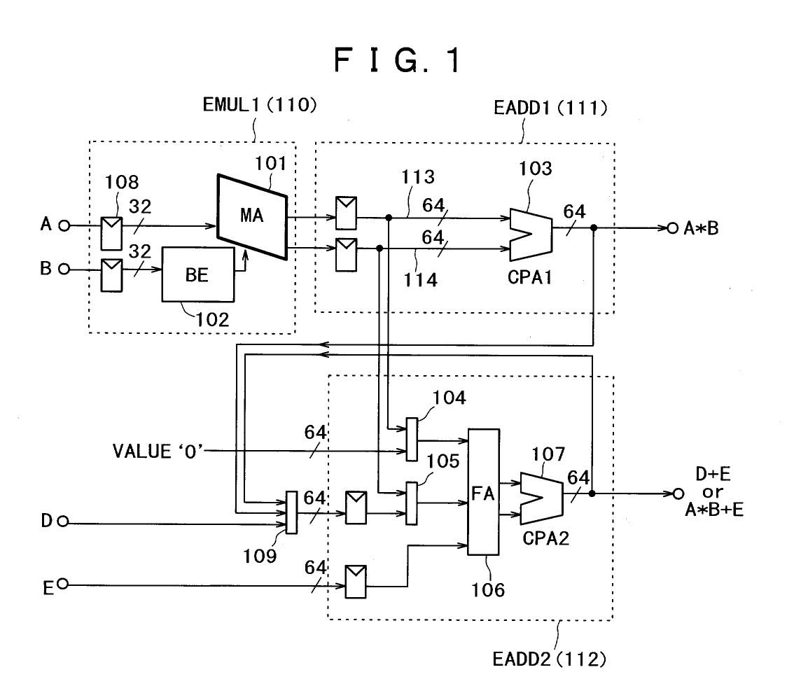

FIG. 1 is a block diagram containing an arithmetic unit of the present invention and data processing circuits around it. The data processing circuits are flip-flops, which are sequential circuits, and additional feedback loops required for pipeline operations.

The reference numeral 101 designates a multiplication array main portion MA and 102 designates a booth encoder BE. 103 and 107 designate 64-bit carry propagate adders. 104 and 105 designate two-input selectors, and 106 designates a 64-bit full addition device. 101 and 102 compute the product of multiplication input signals A (first input node) and B (second input node), respectively, with a carry saved, and output a sum 113 and a carry 114. 113 and 114 are inputted to the carry propagate addition device 103 and the product of A and B is obtained in 115 (first output node). 109 designates a three-input selector.

The multiplication array 101 and the booth encoder 102 together perform one-clock processing, the carry propagate addition device 103 performs one-clock processing, and the full addition device 106 and the carry propagate addition device 107 together perform one-clock processing. The three processings correspond to one-stage processing called in a microprocessor. They will be called a multiplication device (EMUL1) (110), a first addition device (EADD1) (111), and a second addition device (EADD2) (112), respectively. Operations among the stages will be described later using another timing diagram.

Multiplication can be performed by a combination of the multiplication device (110) and the first addition device (111). In this example, 32 bits by 32 bits are computed to output 64 bits. The present specifications use * as a symbol indicating multiplication.

The second addition device (112) computes 64 bits+64 bits to output 64 bits. The second addition device (112) can perform two operations, D+E and A*B+E. More specifically, if the three-input selector 109 selects the lower input in the diagram, and both the two-input selectors 104 and 105 select the lower inputs, (value zero)+D+E is applied to 106, and the second addition device (112) computes D+E. If both the two-input selectors 104 and 105 select the upper inputs, sum 113+carry 114+E is applied, and the EADD2 block (112) computes A*B+E.

In the case where the second addition device (112) performs the operation A*B+E using the arithmetic unit, one characteristic is that first addition processing and second addition processing can be started. Processing is sped by the parallel processing. Specifically, the cases where processing is actually sped will be understood from the following explanation though they depend on operations defined by instruction sets.

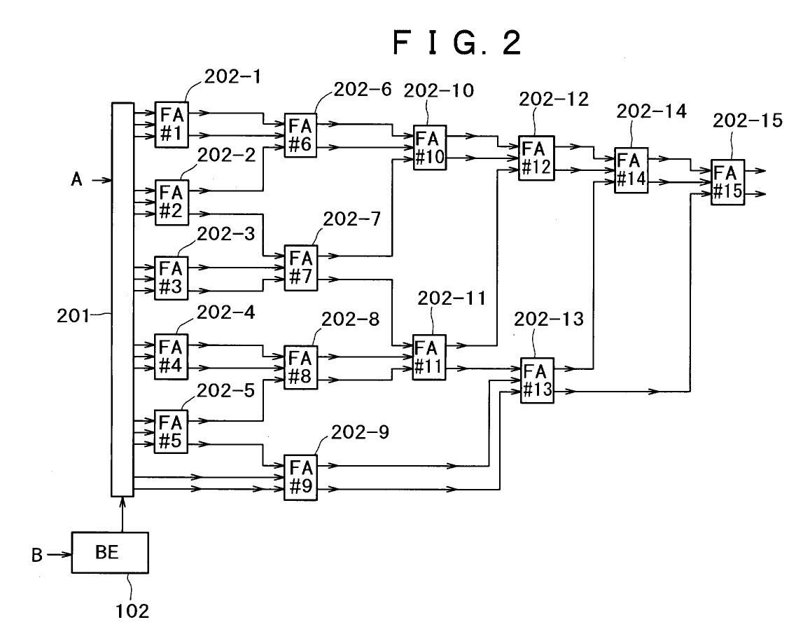

FIG. 2 explains the multiplication array 101 and the booth encoder 102; the inside of the MA 101 is developed in more detail. By using the Booth algorithm described in page 198 of the prior art 1, for multiplication 32*32, 17 terms of data, which are about half 32 terms of data as imaged from human written arithmetic, are added to output a sum and a carry. Herein, 202-1, 202-2, . . . , 202-15, which are respectively bit count full adders of required numbers, add 17 terms in tree shape to output a sum and a carry, which are output signals of the MA 101 of FIG. 1. 201 designates a booth selector. If the delay time of the booth selector is twice the delay time of a full addition device, it will be understood from the diagram that the total delay time of the multiplication array is eight times the delay time of the full addition device.

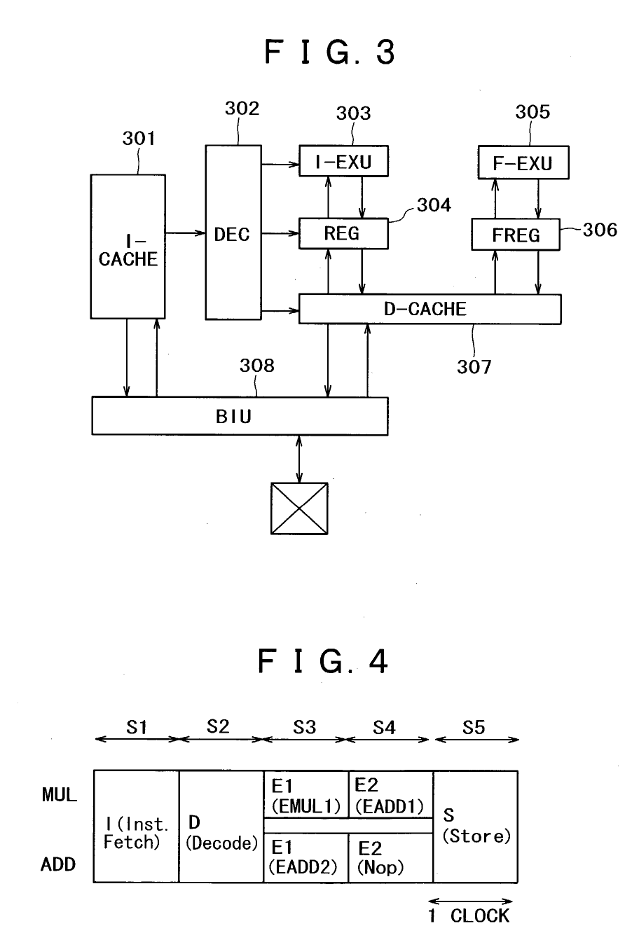

FIG. 3 is a block diagram showing the whole of a processor LSI employing this arithmetic unit. 301 designates an instruction cache and 302 designates an instruction decode unit that controls the arithmetic unit and data movement according to instructions decoded by the instruction decode unit 302. 303 designates an integer part arithmetic unit, and 304 designates an integer register file. 305 designates a floating point unit, and 306 designates a floating point register file. 307 designates a data cache that inputs and outputs data to and from the register files 305 and 306 in response to load and store instructions. 308 designates a bus interface unit that performs input and output with the outside of the LSI.

The arithmetic unit of FIG. 1 is included in the integer part arithmetic unit 303. In addition to the components of FIG. 1, a shift arithmetic unit, a multimedia arithmetic unit, and the like are included as dictated by instruction sets. Since a method of organizing them is not difficult to those skilled in the art, a description of it is omitted.

The integer part arithmetic unit 303 of the LSI primarily performs operations specified by the instruction decode unit 302. In response to one operation instruction, the integer part arithmetic unit 303 receives data required for the operation from the integer register file 304 and returns operation results to the integer register file 304 after the operation.

As seen from FIG. 3, processor LSIs to which an arithmetic unit employing the idea of the present invention is applicable are not limited to special configurations. It will be appreciated that the arithmetic unit can apply widely to general processors.

FIG. 4 shows an instruction pipeline of a processor. It has a five-stage pipeline configuration, and the EMUL1 and EADD2 described previously are processed in a third stage, and the EADD1 is processed in a fourth stage.

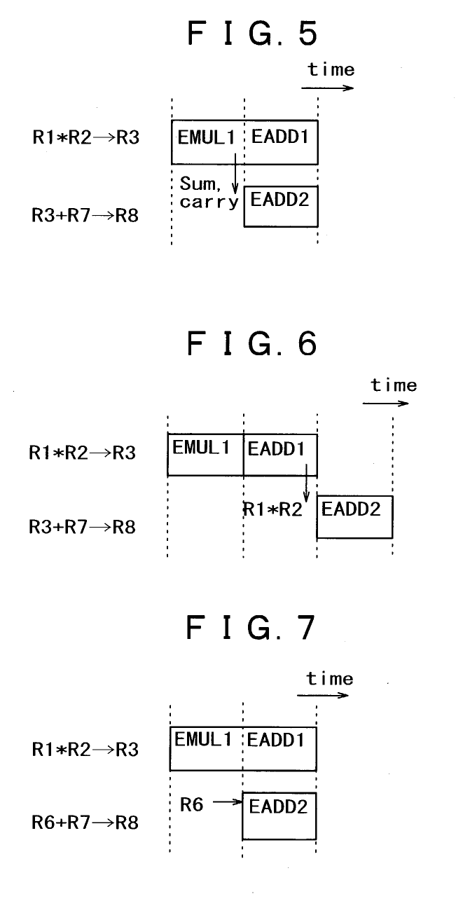

FIGS. 5 to 7 describe, in stages, an example that the arithmetic hardware of FIG. 1 operates according to the pipeline of FIG. 4. The horizontal axis indicates time.

FIG. 5 shows the case where one multiplication instruction is executed and an addition instruction referring to the multiplication result (R3) is executed one clock period later on the pipeline. At the time when the EADD2 stage is started, multiplication processing has proceeded up to EMUL1 and no final multiplication result is yet obtained. Accordingly, a sum signal and a carry signal, outputted from the EMUL1, are bypassed to the EADD2. The bypass processing is performed by the selectors 104 and 105 selecting the upper inputs, respectively.

FIG. 6 shows the case where one multiplication instruction is executed and an addition instruction referring to the multiplication result (R3) is executed two clock periods later on the pipeline. At the time-when the EADD2 stage is started, multiplication processing has proceeded up to EADD1 and a final multiplication result has been obtained. Accordingly, a multiplication result signal outputted from the EADD1 is bypassed to the EADD2. The bypass processing is performed by the selectors 104 and 105 selecting the lower inputs and the selector 109 selecting the second top of the three inputs.

FIG. 7 shows another operation example. One multiplication instruction is executed and an addition instruction not referring to the multiplication result is executed one clock period later on the pipeline. Because the multiplication result does not need to be bypassed, addition data is read from register R6 to perform addition processing. The bypass processing is performed by the selectors 104 and 105 selecting the lower inputs and the selector 109 selecting the third top of the three inputs.

One generalized mnemonic string of a product-sum operation is shown below. Although the mnemonic string does not depend on a specific instruction set, it can be easily made to accommodate a given instruction set. The mnemonic string is

MUL R0,R4,R8 (R0*R4−>R8)

ADD R8,R14,R14 (R8+R14−>R14)

MUL R1,R5,R9

ADD R9,R14,R14

MUL R2,R6,R10

ADD R10,R14,R14.

An expression x=a*b+c*d+e*f can be computed by this instruction string. As seen from the instruction string, a multiplication result is used by addition processing immediately afterward.

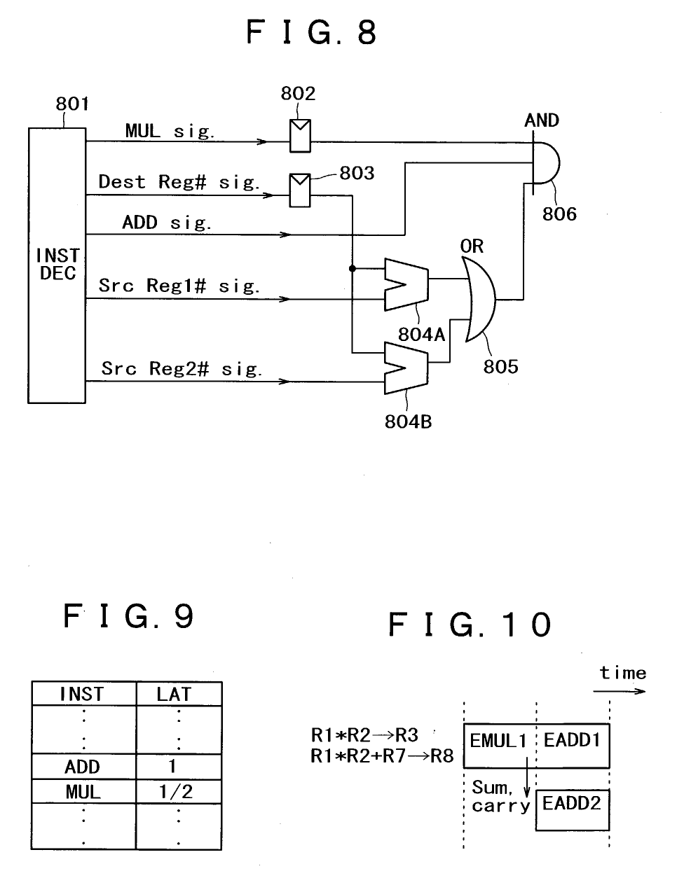

FIG. 8, shows a logical circuit that exists in the instruction decode unit 302 and detects instruction strings having a multiplication-to-addition dependence relationship. Judgment as to whether to bypass a sum and a carry to the EADD2 side consists of the logic of detecting one multiplication instruction and one addition instruction executed one clock period later on a pipeline and judging whether the addition instruction uses a multiplication result.

801 designates a decode combination logical device in the instruction decoder that decodes an instruction synchronously with the D stage. 802 and 803 designate flip-flops for taking timing that make output synchronously with the E1 stage. 804A and 804B designate register number comparators, and 805 designate an two-input OR gate that outputs a logical add. 806 designates a three-input AND gate that outputs a logical product. The flip-flop 802 receives a multiplication result from the instruction decoder, and the flip-flop 803 stores a register number for storing the multiplication result. One number of input registers of an operation instruction in the D stage is inputted to the lower input of the 804A, another number of the input registers of the operation instruction in the D stage is inputted to the lower input of the 804B, and the result of decoding an addition instruction is inputted to the second top input of the 806, with the result that one multiplication instruction and one addition instruction executed one clock later on the pipeline are detected in the output of the 806, and the result of judging whether the addition instruction uses the multiplication result can be outputted. Circuitry incorporating the operations of FIG. 8 may be referred to as a judging device.

FIG. 9 shows part of latencies of the external specification (manual) of the processor described in FIGS. 5 to 8. The unit of latency is clock time. The latency of multiplication instructions is 1 or 2. A latency of 1 refers to the case where a multiplication result is passed to an addition instruction as shown in FIG. 6. A latency of 2 refers to the case where a multiplication result is passed to other than an addition instruction. For example, a computation of a*b*c involves passing a multiplication to another multiplication result, which means a latency of 2.

However, as described in the prior art, multiplications, and additions are most frequently used in the form of combinations of multiplications and additions in common application programs. The fact that a latency in the case of passing multiplication results frequently used to addition instructions is 1 has the effect that an average latency can be lowered to almost 1. Thus, the aspects of the configuration of the present invention will be characteristically understood by the fact that latencies of execution of multiplication instructions depend on instructions executed after the multiplication instructions.

FIG. 10 shows a timing example in a processor controlled by a different instruction set while using the hardware of FIG. 3. This instruction set sets a multiplied value of two registers in a third register (R3 in the example), adds the value of a fourth register to the multiplied value of the two registers, and sets the addition result in a fifth register. In FIG. 3, while a multiplication result to be set in the third register is computed by EMUL1 and EADD1, the result of multiplication and addition to be set in the fifth register is computed by EMUL1 and EADD2.

The characteristic of the above described operations is that two operations can be performed in a user program. Accordingly, a conventional problem of a multiplication-addition instruction (in other words, the problem of intermediate results at the time of multiplication not being able to be fetched) has been solved.

Some effects of the present invention in the above described embodiment are as described below.

(a) Where the arithmetic circuit of the present invention applies to a processor not including a multiplication-addition instruction in an instruction set, a first effect obtained is that continuous execution of a multiplication instruction and an addition instruction reduces execution time. A second effect obtained is that instruction execution can be sped without changing a conventional instruction set system. In short, even existing programs already compiled can be rapidly executed. An attempt to change an instruction set (for example, addition of a multiplication-addition instruction) to achieve high speed would require existing programs to be recompiled from the stage of source programs, causing the heavy load of software modifications. A third effect obtained is that, during execution of multiplication and addition, intermediate results of the multiplication can be reused later. It is to be noted that the arithmetic circuit of the present invention, which is an integration of an existing multiplication device and addition device, introducing substantially no area overhead.

(b) Where the arithmetic circuit of the present invention applies to a processor including a multiplication-addition instruction in an instruction set, a first effect obtained is that, since multiplication, addition, and multiplication-addition can be performed as a unit, the area of the arithmetic circuit can be reduced. A second effect obtained is that, during execution of multiplication-addition, intermediate results of multiplication can be reused later.

(c) Where the arithmetic circuit of the present invention applies to a processor including an instruction set in which both a multiplication operation and a multiplication-addition operation are performed in a single instruction, an effect obtained is that, while both the multiplication operation and the multiplication-addition operation share multiplication hardware, the multiplication-addition operation can be rapidly performed.

What is claimed is:

1. A data processing device including an arithmetic circuit, wherein the arithmetic circuit comprises:
a first input node configured to receive first data;
a second input node configured to receive second data;
a multiplication device configured to receive the first and second data and to output a sum signal and a carry signal, which are partial signals for computing a product between the first and second data;
a first addition device configured to add the sum signal and the carry signal to compute the result of the product between the first and second data;
a first output node configured to output a computation result of the first addition device;
a third input node configured to receive third data;
a second addition device configured to receive the third data, the sum signal, and the carry signal, and further configured to add the third data to a product between the first and the second data; and
a second output node configured to output a computation result of the second addition device.

2. The data processing device of claim 1, wherein an instruction set of the data processing device includes a multiplication instruction for computing a product between two data and outputting a result, and an add instruction for computing a sum between two data and outputting a result, the arithmetic circuit further comprising:
a fourth input node configured to receive fourth data;
a first selecting circuit configured to select one of the sum signal and a zero signal to obtain a first selection, and further configured to supply the first selection to an input of the second addition device; and
a second selecting circuit configured to select one of the carry signal and the fourth data to obtain a second selection, and further configured to supply the second selection to an input of the second addition device, wherein when the add instruction for adding the third and fourth data is inputted to the data processing device, the first selection circuit selects a zero signal, the second selection circuit selects the fourth data, and the result of adding the third and fourth data is outputted from the second output node.

3. The data processing device of claim 2, wherein when the multiplication instruction for multiplying the first data and the second data is inputted to the data processing device, the first addition device outputs the result of multiplying the first and second data from the first output node.

4. The data processing device of claim 1, wherein an instruction set of the data processing device includes a multiplication instruction for computing a product between two data and outputting a result, and an add instruction for computing a sum between two data and outputting a result, the arithmetic circuit further comprising:
a fourth input node configured to receive fourth data;
a first selecting circuit configured to select one of the sum signal and a zero signal to obtain a first selection, and further configured to supply the first selection to an input of the second addition device; and
a second selecting circuit configured to select one of the carry signal and the fourth data to obtain a second selection, and further configured to supply the second selection to an input of the second addition device, wherein when the multiplication instruction for multiplying the first and second data, and the addition instruction for adding the third data to the result of multiplying the first and second data are successively inputted to the data processing device, the first selection circuit selects the sum signal, the second selection circuit selects the carry signal, and the second addition device outputs the result of adding the third data to the product between the first and second data from the second output node.

5. The data processing device of claim 1, the arithmetic circuit further comprising:
a fourth input node configured to receive fourth data;
a first selecting circuit configured to select one of the sum signal and a zero signal to obtain a first selection, and further configured to supply the first selection to an input of the second addition device; and
a second selecting circuit configured to select one of the carry signal and the fourth data to obtain a second selection, and further configured to supply the second selection to an input of the second addition device, wherein the first addition device is a first carry propagate addition device for computing the sum of the sum signal and the carry signal, and wherein the second addition device includes,
a carry save addition device configured to receive output signals of the first and second selecting circuits and the fourth data, and
a second carry propagate addition device configured to receive output of the carry save addition device and to output a result to the second output node.

6. The data processing device of claim 1, wherein an instruction set of the data processing device includes a multiplication instruction for computing a product between two data and outputting a result, an add instruction for computing a sum between two data and outputting a result, and a multiplication-addition instruction for adding third data to the product of two data and outputting a result, wherein the arithmetic circuit is configured to execute the multiplication instruction, the addition instruction, and the multiplication-addition instruction.

7. The data processing device of claim 6, wherein the first addition device includes a first carry propagate addition device for computing the sum of the sum signal and the carry signal, and wherein the second addition device includes,
a carry save addition device, and
a second carry propagate addition device configured to receive output of the carry save addition device and to output a result to the second output node.

8. The data processing device of claim 1, wherein the multiplication device includes a multiplication array and a booth encoder, and wherein the first addition device includes a first carry propagate addition device for computing the sum of the sum signal and the carry signal; and wherein the second addition device includes,
a carry save addition device, and
a second carry propagate addition device configured to receive output of the carry save addition device and to output a result to the second output node.

9. The data processing device of claim 1, wherein an instruction set of the data processing device includes an addition instruction for adding two data and a multiplication instruction for multiplying two data, the data processing device further including:
an judging device configured to determine whether the addition instruction is inputted following the multiplication instruction, and further configured to determine whether the addition instruction to be executed uses a computation result of the multiplication instruction.

10. The data processing device of claim 1, wherein the arithmetic circuit is configured to operate as one of a following device according to instructions received by the data processing device:
a two-input and one-output multiplication device;
a two-input and one-output addition device; and
a three-input and one-output multiplication-addition device.

11. The data processing device of claim 1, further including:
a first register;
a second register; and
a third register, wherein upon receiving a first instruction, the data processing device computes the product of the respective data of the first register and the second register in the arithmetic circuit, and stores a result in one of the first register and the second register, and wherein upon receiving a second instruction, the data processing device multiplies the respective data of the first register and the second register, adds the data of the third register to the result of the multiplication in the arithmetic circuit, and stores a result in one of the first register, the second register, and the third register.

12. A data processing device comprising a multiplication instruction for multiplying two data in an instruction set, wherein a latency required to execute the multiplication instruction depends on an instruction executed after the multiplication instruction.

13. The data processing device of claim 12, wherein the data processing device further comprises an addition instruction for adding two data in the instruction set, and wherein the latency required to execute the multiplication instruction is equivalent to one of:
the execution latency of the addition instruction; and
half the execution latency of the addition instruction.

14. The data processing device of claim 12, wherein the data processing device further comprises an arithmetic circuit for executing the multiplication instruction and the addition instruction, wherein the arithmetic circuit includes:
a multiplication device configured to receive first data and second data, and further configured to output a sum signal and a carry signal, which are partial signals for computing a product between the first and second data;
a first addition device configured to add the sum signal and the carry signal to obtain the result of the product between the first data and second data; and
a second addition device configured to receive third data, the sum signal, and the carry signal, and further configured to compute the result of adding the third data to the product between the first data and second data.

15. A data processing device having an arithmetic circuit, wherein the arithmetic circuit comprises:
a first input node configured to receive first data;
a second input node configured to receive second data;
a multiplication device configured to receive the first and the second data and to output a sum signal and a carry signal, which are partial signals for computing a product between the first and the second data;
a first addition device configured to add the sum signal and the carry signal to compute the result of the product between the first and the second data;
a first output node configured to output a computation result of the first addition device;
a third input node configured to receive third data;
a fourth input node configured to receive fourth data;
a second addition device; and
a second output node configured to output a computation result of the second addition device, wherein the second addition device is configured to switch between the operation of adding the third data, the sum signal, and the carry signal, and the operation of adding the third data and the fourth data.

16. The data processing device of claim 15, wherein the arithmetic circuit is configured to operate as one of a following according to instructions received by the data processing device:
a two-input and one-output multiplication device;
a two-input and one-output addition device; and
a three-input and one-output multiplication-addition device according to instructions inputted to the data processing device.

17. The data processing device of claim 15, wherein an instruction set of the data processing device includes an addition instruction for adding two data and a multiplication instruction for multiplying two data, and wherein the data processing device further comprises an judging device configured to determine whether the addition instruction is inputted following the multiplication instruction, and further configured to determine whether the addition instruction to be executed uses a computation result of the multiplication instruction.
